(19) United States
(12) Patent Application Publication
(10) Pub. No.: US 2007/0174211 A1
(43) Pub. Date: Jul. 26, 2007

(54) AUTOMATIC PACKAGING SYSTEM AND METHOD

(75) Inventors: CHUN-NAN OU, Tu-Cheng,Taipei Hsien (TW); Lin Yan, Shenzhen (CN); Zhi-Wei Wang, Shenzhen (CN); Min Guo, Shenzhen (CN); Yu-Wu Yang, Shenzhen (CN); Lin-Sheng Hu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng,Taipei Hsien (TW)

(21) Appl. No.: 11/308,950

(22) Filed: May 29, 2006

(30) Foreign Application Priority Data
Jan. 20, 2006 (TW) 095102379

(51) Int. Cl. G06F 17/00; G06G 7/00

(52) U.S. Cl. 705/400

(57) ABSTRACT

An automatic packaging system is provided. The automatic packaging system includes a user interface, a selection-controlling module, an alarm-controlling module, and a package module. The user interface is for receiving user input. The selection-controlling module is for enabling and controlling a vibrating plate to select parts according to the user input, and generating a detection signal. The alarm-controlling module is for generating a package signal according to the detection signal and the user input. The package module is for packaging the parts according to the package signal.

### FIELD OF THE INVENTION

The invention relates to an automatic packaging system and method.

### DESCRIPTION OF RELATED ART

Nowadays, parts and accessories are widely used in the machining industry. In a typical production or assembly process, a large number of parts need to be packaged.

One solution to package the parts is to manually select the parts first and then package them. However, this redundant manual method may cause a worker to get tired, or lose concentration resulting in a lack of efficiency. Moreover, the time spent on manual selection of parts is long resulting in greater labor costs and more time getting product to market.

### SUMMARY OF THE INVENTION

An automatic packaging system is provided. The automatic packaging system includes a user interface, a selection-controlling module, an alarm-controlling module, and a package module. The user interface is for receiving user input. The selection-controlling module is for enabling and controlling a vibrating plate to select parts according to the user input, and generating a detection signal. The alarm-controlling module is for generating a package signal according to the detection signal and the user input. The package module is for packaging the parts according to the package signal.

Moreover, an automatic packaging method is also provided. The automatic packaging method includes receiving user input, selecting parts according to the user input, confirming whether the selected parts correspond with the user input, generating a package signal if the selected parts correspond with the user input, and packaging the parts according to the package signal.

Other advantages and novel features will become more apparent from the following detailed description when taken in conjunction with the accompanying drawings, in which:

### BRIEF DESCRIPTION OF THE DRAWINGS

FIG. 1 is a block diagram of an automatic packaging system in accordance with an exemplary embodiment of the invention;

FIG. 2 is a flow chart of an automatic packaging method in accordance with another exemplary embodiment of the invention;

FIG. 3 is a flow chart of an automatic packaging method in accordance with a further exemplary embodiment of the invention; and

FIG. 4 is a flow chart of a selection-controlling module and a vibrating plate in accordance with a still further exemplary embodiment of the invention.

### DETAILED DESCRIPTION OF THE INVENTION

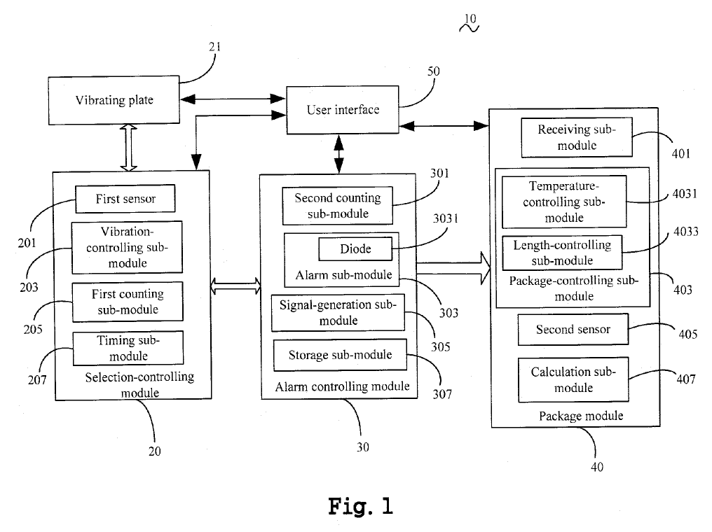

FIG. 1 is a block diagram of an automatic packaging system 10 in accordance with an exemplary embodiment of the invention. The automatic packaging system 10 includes a selection-controlling module 20, an alarm-controlling module 30, a package module 40, at least one vibrating plate 21, and a user interface 50.

The user interface 50 is for receiving user input. In this embodiment, content of the user input includes vibration velocity of the vibrating plate 21, a number of the parts in a packing bag, a preset alarm value, and a temperature and a length of the packing bag during a packaging process. The preset alarm value is defined as the maximum number of the parts that can be accommodated in the packing bag.

The vibrating plate 21 is for selecting the parts according to the vibration velocity.

The selection-controlling module 20 includes a first sensor 201, a vibration-controlling sub-module 203, a first counting sub-module 205, and a timing sub-module 207. The first sensor 201 is connected with the vibrating plate 21 for sensing selected parts. In this embodiment, the first sensor 201 is a fiber optic sensor. The vibration-controlling sub-module 203 is connected with the vibrating plate 21 for controlling the vibration velocity of the vibrating plate 21. The first counting sub-module 205 is connected with the first sensor 201 for counting the number of the selected parts, and generating a detection signal if the number of the selected parts equals a preset number of the parts to be placed in the packing bag. The timing sub-module 207 is for controlling a delay of the operation of the vibrating plate 21.

The alarm-controlling module 30 is for generating an alarm signal or a package signal according to the detection signal and the preset alarm value. The alarm-controlling module 30 includes a second counting sub-module 301, an alarm sub-module 303, a signal-generation sub-module 305, and a storage sub-module 307. The second counting sub-module 301 is for receiving the detection signal from the selection-controlling module 20, and determining whether the number of the selected parts equals the preset alarm value. The alarm-controlling sub-module 303 is for generating an alarm signal if the number of the selected parts is not equal to the preset alarm value, and providing the alarm signal to a user by some visual or audio means such as illuminating a diode 3031. The signal-generation sub-module 305 is for generating a package signal if the number of the selected parts equals the preset alarm value, and transmitting the package signal to the package module 40. The storage sub-module 307 is for storing the preset alarm value.

The second counting sub-module 301 generates a delay signal after determining whether the number of the selected parts equals the preset alarm value, and transmitting the delay signal to the selection-controlling module 20, in order to reset the first counting sub-module 205 therein.

The package module 40 includes a receiving sub-module 401, a package-controlling sub-module 403, a second sensor 405, and a calculation sub-module 407. The receiving sub-module 401 is for receiving the package signal from the alarm-controlling module 30, and transmitting the package signal to the package-controlling sub-module 403. The package-controlling sub-module 403 packages the selected parts after receiving the package signal. The second sensor 405 is connected with the package-controlling sub-module 403 for sensing the number of the packing bags that have been packaged. In this embodiment, the second sensor 405 is a position sensor. The calculation sub-module 407 is connected with the second sensor 405 for calculating a total of the packing bags that have been packaged.

The package-controlling sub-module 403 includes a temperature-controlling sub-module 4031 and a length-controlling sub-module 4033. The temperature-controlling sub-module 4031 is for controlling the temperature of the packing bag during the packaging process. The length-controlling sub-module 4033 is for controlling the length of the packing bag during the packaging process.

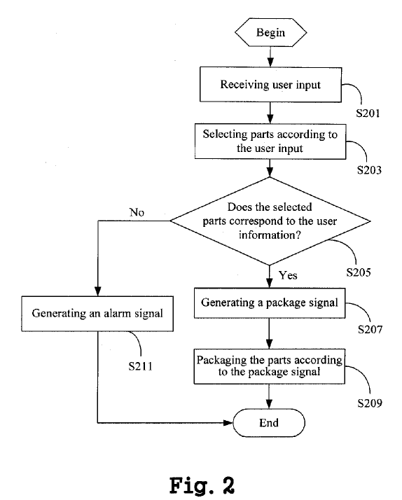

FIG. 2 is a flow chart of an automatic packaging method in accordance with a another exemplary embodiment of the invention. In step S201, the automatic packaging system 10 receives the user input via the user interface 50. The content of the user input includes vibrating velocity of the vibrating plate 21, the number of the parts to be placed in the packing bag, a preset alarm value, and the temperature and the length of the packing bag during the packaging process. In step S203, the vibrating plate 21 selects the parts according to the user input. In step S205, the alarm-controlling module 30 confirms whether the selected parts correspond with the user input. If the selected parts correspond with the user input, the process proceeds to step S207, where the alarm-controlling module 30 generates the package signal. In step S209, the package module 40 packages the parts according to the package signal.

In step S205, if the selected parts do not correspond with the user input, the process proceeds to step S211, where the alarm-controlling module 30 generates the alarm signal, and provides the alarm signal to the user.

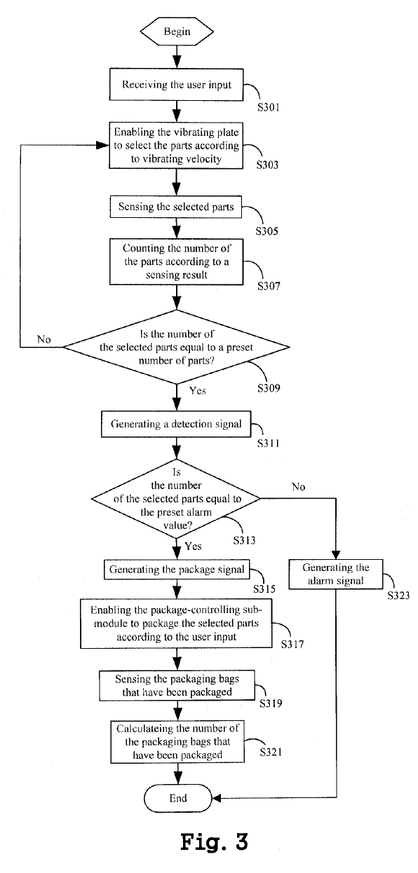

FIG. 3 is a flow chart of the automatic packaging method in accordance with a further exemplary embodiment of the invention. In step S301, the automatic packaging system 10 receives the user input via the user interface 50. The content of the user input includes the vibrating velocity of the vibrating plate 21, the number of the parts to be placed in the packing bag, a preset alarm value, and the temperature and the length of the packing bag during the packaging process. In step S303, the vibration-controlling sub-module 203 enables the vibrating plate 21 to select the parts according to the vibrating velocity. In step S305, the first sensor 201 senses the selected parts, and transmits a sensing result to the first counting sub-module 205 and the second counting sub-module 301. In step S307, the first counting sub-module 205 counts the number of the parts according to the sensing result. In step S309, the first counting sub-module 205 determines whether the number of the selected parts equals a preset number of the parts to be selected. If the number of the selected parts equals the preset number, the process proceeds to step S311 described below. If the number of the selected parts does not equal to the preset number of the parts, the process returns to step S303.

In step S311, the first counting sub-module 205 generates the detection signal, transmits the detection signal to the alarm-controlling module 30, and enables the alarm-controlling module 30 to operate. In step S313, the second counting sub-module 301 determines whether the number of the selected parts equals the preset alarm value. If the number of the selected parts equals the preset alarm value, the process proceeds to step S315, where the signal-generation sub-module 305 generates a package signal, and transmits the package signal to the package module 40. In step S317, the package module 40 receives the package signal via the receiving sub-module 401 and enables the package-controlling sub-module 403 to package the selected parts according to the user input. In step S319, the second sensor 405 senses the packing bags that have been packaged. In step S321, the calculation sub-module calculates the number of the packing bags that have been packaged, and sends a calculation result to the user.

In step S313, if the number of the selected parts does not equal the preset alarm value, the alarm-controlling sub-module 303 generates an alarm signal, and provides the alarm signal to the user by illuminating the diode 3031.

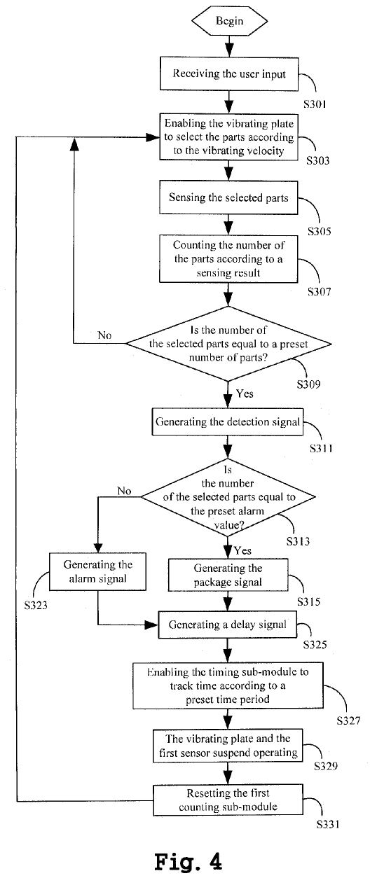

FIG. 4 a flow chart of the selection-controlling module 20 and the vibrating plate 21 in accordance with a still further exemplary embodiment of the invention. All steps prior to step S315 are the same as FIG. 3. In step S325, the second counting sub-module 301 generates a delay signal, and transmits the delay signal to the selection-controlling module 20. In step S327, the selection-controlling module 20 enables the timing sub-module 207 to track time according to a preset time period. In step S329, the vibrating plate 21 and the first sensor 201 suspend operating. In step S331, the first counting sub-module 205 is reset. The process then returns to steps 303. In this embodiment, the time period equals a time required to reset the first counting sub-module 205.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. An automatic packaging system, comprising:
a user interface for receiving user input;
a selection-controlling module for enabling and controlling a vibrating plate to select parts according to the user input, and for generating a detection signal;
an alarm-controlling module for generating a package signal according to the detection signal and the user input; and
a package module for packaging the parts according to the package signal.

2. The automatic packaging system as recited in claim 1, wherein the selection-controlling module comprises:
at least one first sensor for sensing the selected parts; and
a first counting sub-module for counting the number of the selected parts, and generating the detection signal.

3. The automatic packaging system as recited in claim 2, wherein the selection-controlling module further comprises:
a vibration-controlling sub-module for controlling vibration velocity of the vibrating plate; and
a timing sub-module for controlling a delay of operation of the vibrating plate.

4. The automatic packaging system as recited in claim 1, wherein the alarm-controlling module is further for generating an alarm signal according to the detection signal and the user input.

5. The automatic packaging system as recited in claim 4, wherein the alarm-controlling module comprises a storage sub-module for storing a preset alarm value.

6. The automatic packaging system as recited in claim 5, wherein the alarm-controlling module further comprises:
a second counting sub-module for receiving the detection signal from the selection-controlling module, and determining whether the preset alarm value equals the number of the selected parts; and
an alarm sub-module for generating the alarm signal if the preset alarm value equals the number of the selected parts.

7. The automatic packaging system as recited in claim 6, wherein the alarm-controlling module further comprises a signal-generation sub-module for generating the package signal if the preset alarm value equals the number of the selected parts.

8. The automatic packaging system as recited in claim 7, wherein the package module comprises a receiving sub-module for receiving the package signal from the alarm-controlling module.

9. The automatic packaging system as recited in claim 8, wherein the package module further comprises a package-controlling sub-module for controlling packing bags during a packaging process.

10. The automatic packaging system as recited in claim 9, wherein the package module further comprises:
a second sensor for sensing the packing bags that have been packaged; and
a calculation sub-module for calculating a total of the packing bags that have been packaged.

11. The automatic packaging system as cited in claim 10, wherein the second sensor is a position sensor.

12. The automatic packaging system as cited in claim 9, wherein the package-controlling sub-module comprises a temperature-controlling sub-module for controlling a temperature of the packing bag during the packaging process.

13. The automatic packaging system as cited in claim 12, wherein the package-controlling sub-module further comprises a length-controlling sub-module for controlling length of the packing bags during the packaging process.

14. An automatic packaging method, comprising:
receiving user input;
selecting parts according to the user input;
confirming whether the selected parts correspond with the user input;
generating a package signal if the selected parts correspond with the user input; and
packaging the parts according to the user input and the package signal.

15. The automatic packaging method as cited in claim 14, wherein the user input comprises:
vibration velocity of a vibrating plate;
the number of the parts in a packing bag; and
a preset alarm value.

16. The automatic packaging method as cited in claim 14, wherein the step of selecting the parts according to the user input comprises:
enabling the vibrating plate to select the parts according to the vibration velocity of the vibrating plate;
sensing the selected parts; and
counting the number of the selected parts according to a sensing result.

17. The automatic packaging method as cited in claim 14, wherein the step of confirming whether the selected parts correspond with the user input comprises:
determining whether the number of the selected parts equal to the preset number of the parts to be placed in the packing bag; and
generating a detection signal if the number of the selected parts equals to the preset number of the parts to be placed in the packing bag.

18. The automatic packaging method as cited in claim 17, wherein the step of confirming whether the selected parts correspond with the user input further comprises:
determining whether the number of the selected parts equals the preset alarm value according to the detection signal;
generating an alarm signal if the number of the selected parts is not equal to the preset alarm value; and
generating the package signal if the number of the selected parts equals the preset alarm value.

19. The automatic packaging method as cited in claim 18, wherein the step of confirming whether the selected parts correspond with the user input further comprises:
packaging the parts according to a temperature and a length of the packing bag;
sensing the packing bags that have been packaged; and
calculating a total of the packing bags that have been packaged.
